(19) United States
(12) Patent Application Publication
(10) Pub. No.: US 2010/0119994 A1
(43) Pub. Date: May 13, 2010

(54) ARTIFICIAL DENTAL PROTHESIS, METHOD FOR THE PRODUCTION OF AN ANCHORING PART

(76) Inventor: Johan Feith, Muenchen (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(21) Appl. No.: 12/596,738

(22) PCT Filed: Mar. 31, 2009
(86) PCT No.: PCT/EP08/02539

§ 371 Date: Oct. 20, 2009

(30) Foreign Application Priority Data
Apr. 20, 2007 (DE) 10 2007 018 779.5
Jun. 6, 2007 (DE) 10 2007 026 325.4

(51) Int. Cl. A61C 13/225; A61C 8/00

(52) U.S. Cl. 433/173; 433/172

(57) ABSTRACT

An artificial dental prosthesis includes a crown and an implant, the implant having an abutment portion and an anchoring portion, the anchoring portion having a region for receiving the abutment portion, and wherein the anchoring portion is connected to the abutment portion forming an external contact joint. The artificial dental prosthesis is designed such that the crown covers the contact joint at least in sections.

### CROSS-REFERENCE TO RELATED APPLICATIONS

This application is a Section 371 of International Application No. PCT/EP2008/002539, filed Mar. 31, 2008, which was published in the German language on Oct. 30, 2008, under International Publication No. WO 2008/128620 A1 and the disclosure of which is incorporated herein by reference.

### BACKGROUND OF THE INVENTION

The invention relates to an artificial dental prosthesis having a crown or similar superstructure and an implant for receiving the crown, the implant having an abutment portion and an anchoring portion, the anchoring portion having a region for receiving the abutment portion and being formed at least in sections from a first material, the anchoring portion having a region for receiving a terminating region of the crown, and the abutment portion being formed at least in sections from a second material, which is softer than the first material. In addition, the invention relates to a method for production of an anchoring portion.

Two-part dental implants are known from the prior art, such as U.S. Patent Application Publication US 2003/0104338 A1. These are made up of an anchoring portion and an abutment portion. Following implantation of the anchoring portion and having waited for any potentially necessary healing time to pass, the abutment portion is screwed or bonded onto the anchoring portion. The abutment portion then supports the crown or the appropriate superstructure. A gap, in which bacteria may become established, exists between the anchoring portion and the abutment portion. This may sometimes lead to bacterially-induced bone resorption. The profile of the natural gingival boundary also changes because the bone recedes. The gingiva recede or become displaced in such a way that transitions between the implant and the crown sometimes become visible. This disrupts the visual appearance of the artificial dental prosthesis. Titanium implants which become exposed are particularly unappealing and aesthetically undesirable.

German published patent application DE 101 59 683 A1 thus proposes the use of one-piece implants, particularly based on zirconium oxide, wherein the abutment portion and the anchoring portion are made in one piece. After sintering, such one-piece implants are practically ungrindable using conventional means. That is, although the zirconium oxide may also be ground in the sintered state, micro-cracks occur in the process, which sometimes result in the artificial dental prosthesis becoming unusable. Subsequent adjustment of the implant is, therefore, impossible. The requirements on the implant production process and on the person placing the implant are correspondingly high.

U.S. Patent Application Publication 2004/0241610 A1 proposes a two-part implant, comprising an anchoring portion and an abutment portion made of titanium. The abutment portion is partially inserted into the anchoring portion and joined thereto by way of a screw thread. The implant has an external contact joint which is disposed at a distinct distance from the bone when the implant is placed. The implant is designed such that the external contact joint is sealed at least in sections by a crown to be attached.

Grinding, for slight corrections for example, is inadvisable in the case where titanium implants are used. As the implants have a high level of heat conductivity, the local temperature increase due to grinding is distributed through the whole implant. The implant heats up and bone cells which are in direct contact with the implant die off. Any healing success already achieved is reversed.

Moreover, metal splinters, which are detached and greatly accelerated by the grinding tool, may penetrate the patient's gums. It is frequently impossible to remove them subsequently. They remain in the gum and sometimes noticeably discolor the tissue.

A multi-part artificial dental prosthesis, substantially comprised of zirconium oxide, is disclosed by German Utility Model application DE 20 2004 017 481 U1 It shows an implant for receiving a crown, wherein the implant comprises an anchoring portion of zirconium oxide and an abutment portion of fiberglass pins which are bonded to the anchoring portion. The abutment portion emerges in that at least two fiberglass pins are inserted in openings in the anchoring portion and are coated with a composite layer to form a suitable abutment portion.

There is no provision for adapting the abutment portion coated with the composite layer to local conditions.

### BRIEF SUMMARY OF THE INVENTION

Proceeding from this prior art, the object of the present invention is to provide an artificial dental prosthesis which is functional, easy to place and adaptable, and with which ingrowth is fast and secure. The artificial dental prosthesis should have a visually appealing appearance in the placed condition, and it should mainly be possible to prefabricate it mechanically. Appropriate use of the dental prosthesis should also be demonstrated.

This object is achieved by an artificial dental prosthesis of the type described at the outset, wherein the abutment portion is formed in one-piece in such a manner that it can be ground in situ. The object is further achieved by the use of an abutment portion in a corresponding dental prosthesis such that the abutment portion can be ground in situ after insertion in the anchoring portion placed in the jaw to adapt it to local conditions.

In particular, the object is achieved by an artificial dental prosthesis which comprises a crown or similar superstructure and an implant for receiving the crown,

wherein the implant has an abutment portion and an anchoring portion,

wherein the anchoring portion has an abutment portion receiving region for receiving the abutment portion and is formed at least in sections from a first material,

wherein the anchoring portion includes a crown receiving region for receiving a terminating region of the crown,

wherein the abutment portion is formed at least in sections from a second material, which is softer than the first material, and

wherein the abutment portion is formed in one-piece in such a manner that it can be ground in situ.

A central idea of the invention is thus that the contact joint, that is, the joining section between the abutment portion and the anchoring portion, is covered and/or sealed at least in sections by the crown. Bacteria cannot accumulate in this gap and cause any bone loss.

Moreover, the abutment portion is one-piece and formed from such a material that it can be ground in situ.

The two-part structure of the implant or supporting element enables it to keep the load on the anchoring portion as low as possible during the ingrowth phase. Here the anchoring portion without the abutment portion may be sealed in such a way that its termination is considerably below the occlusal surface which ensures that ingrowth is fast and secure.

By covering the external contact joint with the crown, it is possible, even in cases where there is a slight loss of gingival height, to achieve a visually appealing result.

Moreover, by using different materials for the abutment portion and the anchoring portion, it is possible to choose the properties thereof such that easy placement of the implant and working thereon is guaranteed. It is possible to grind the abutment portion or abutment without a problem.

According to one embodiment of the invention, the anchoring portion has a crown receiving region for receiving a terminating region of the crown. In the fitted condition, a lower end region of the crown thus attaches directly to the anchoring portion. The joint may, for example, be created by a bonded joint. The contact joint situated inside the crown is sealed tight. Forces which act on the crown are transferred directly to the anchoring portion.

Furthermore, the anchoring portion may have a frustoconical section, in particular with a concave lateral surface for receiving part of the crown. The crown receiving region may, for example, be formed at least in part by these lateral surfaces. The transition between crown and supporting element may be designed particularly advantageously due to the special development of the crown receiving region.

The frustoconical section may have a height which is greater or smaller than 3% of the anchoring portion's overall height, in particular approximately equal to 5% of the anchoring portion's overall height. The lateral surface is designed to be large-area in such a manner that a tight joint can be achieved with the crown resting thereon. The lateral surface is also suitable to establish a secure mechanical joint between crown and anchoring portion. Forces which act on the crown are transferred directly to the anchoring portion.

In one embodiment, the anchoring portion is substantially cylindrical in design, whereby the cap area of the cylinder forms at least a section of the abutment portion receiving region. The cylindrical shape described also includes a three-dimensional body similar to a cylinder, which has an oval or approximately oval base area. The body may likewise have in sections a circular (preferably in the bottom section) and an elliptical (preferably in the top section) cross-section. Part of the abutment portion receiving region thus extends substantially perpendicular to the longitudinal axis of the anchoring portion and/or of the supporting element. It is suitable to guarantee a secure seat of the abutment portion on the anchoring portion.

In one embodiment, the anchoring portion includes a screw threaded section. The screw threaded section guarantees a secure seat of the anchoring portion in the jaw. The anchoring portion may be screwed and/or hammered into the jaw.

In one embodiment, the anchoring portion includes a receiving channel for receiving the abutment portion. The receiving channel runs substantially parallel to the longitudinal axis of the anchoring portion. The receiving channel, into which a corresponding mating part of the abutment portion may engage, increases the stability of the two-part implant, particularly in relation to torsional forces and forces which act at right angles to the longitudinal direction or the longitudinal axis of the implant. The receiving channel may be designed such that an insertion instrument ensures anti-rotational reception. Insertion of the anchoring portion, particularly the screwing in thereof, is thus made easier. In this manner it is possible to ensure a high level of precision when placing the dental implant.

The first material preferably belongs to the material group of technical ceramics, in particular an oxide ceramic in this case.

The anchoring portion is preferably fabricated from zirconium oxide. A zirconium oxide ceramic, which has a very high strength, is particularly suitable for the dental implant. In addition, the white color of the zirconium oxide is advantageous. Even if some sections of the anchoring portion are exposed, they are visually inconspicuous as they are matched to the overall appearance of the crown. It is possible to shade the zirconium oxide in the green compact phase.

In one embodiment, the abutment portion includes a grindable material, particularly a synthetic material. The material is characterized particularly in that it can be worked on or ground using conventional dental tools without the work being damaged (e.g., micro-cracks). The abutment portion may thus also be worked on after placement of the implant, including the anchoring portion and the abutment portion. Consequently, the dental implant can be adapted to the local conditions. Serial (mass) production of anchoring portions and abutment portions, which can be individualized, is possible. Inaccuracies which have arisen during placement of the anchoring portion may be compensated by subsequent work on the abutment portion.

The abutment portion may be formed from a synthetic material totally or only in one section, which directly contacts the crown. As synthetic material has lower heat conductivity, it is particularly suitable as a material for the abutment portion. The heat arising on grinding the top end of the abutment portion is only conducted further to a small extent and may easily be dissipated by the provision of suitable cooling measures, water irrigation for example. The implant heats up merely in the upper region in which there is no contact with the bone tissue. Dissipation of the heat passing into deeper regions is prevented, and as a result gingiva and bone are not damaged.

In one embodiment, the abutment portion includes CFRP (carbon fiber reinforced plastic) and/or GFRP (glass fiber reinforced plastic). The durability of the superstructure element and the whole dental implant is thus increased. The fibers are preferably aligned along a longitudinal direction of the abutment portion.

The crown is preferably bonded to the implant. A bonded joint may exist between crown and abutment portion and/or between crown and anchoring portion.

In addition, the abutment portion may be bonded to the anchoring portion, particularly in the abutment portion receiving region.

In one embodiment, the anchoring portion has a subgingival section with an outer surface, of which a significant region is particularly suitable for contacting with the gingiva and/or for intergrowth with the bone. The structure and/or the surface of the subgingival section is thus formed in such a manner that it ensures good integration into the existing tissue and bone structures. Preferably, a significant region of the outer surface or more than 30% of the outer surface of the subgingival section has an arithmetical mean roughness value in the range of 8 μm to 30 μm (in particular greater than 12 μm). The high degree of roughness of the outer surface increases osseointegration and thus the dental implant's firm seat in the bone.

Rapid ingrowth of the biological tissue into the dental implant's surface structure is accelerated in that a significant region of the outer surface, in particular more than 30% of the outer surface of the subgingival section, is hydroxylated.

It is advantageous if the anchoring portion is shaded at least in sections. It is known in dentistry to shade zirconium oxide in the green compact phase, that is before sintering. The shade may be selected according to a guide, for example the shade of the adjacent teeth. Preferably, only the region which is adjacent to the terminating edge of the crown is shaded. If a gap occurs between gingiva and crown during placement of the implant, then due to the shading of the anchoring portion it is visually inconspicuous.

In addition, the object is achieved by a method in which the dental implant adjoining the frustoconical section as well as the frustoconical section itself are designed asymmetrically, deviating from a circular cross-section.

An important aspect in the production of an anchoring portion for an artificial dental prosthesis is that of shading at least one colored section of the anchoring portion, particularly in accordance with the associated crown. As a result, the transition from anchoring portion to crown is visually inconspicuous. During production according to one embodiment of the invention, a green compact corresponding to the anchoring portion to be manufactured is formed from zirconium oxide and shaded at least in sections prior to sintering.

Preferably, only a section of the anchoring portion is shaded. In particular, the colored section is located outside the regions which are inserted in the bone for anchoring the anchoring portion.

In one embodiment, the colored section is situated above the screw threaded section.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. The drawings show:

FIG. 1 is a schematic sectional view through an implant comprising abutment portions and anchoring portion according to one embodiment of the invention;

FIG. 2 is a schematic sectional view through the implant according to FIG. 1 with crown;

FIG. 3 is a detailed sectional view of the dashed outline area of FIG. 1;

FIG. 4 is a view from above onto the anchoring portion of the implant according to FIG. 1;

FIG. 5 is a sectional view of an anchoring portion inserted in bone and tissue;

FIG. 6 is a sectional view of a further embodiment of an implant according to the invention with crown;

FIG. 7 is a sectional view through the same embodiment as FIG. 6 but at a right angle thereto; and

FIG. 8 is a schematic sectional view from above onto the embodiment according to FIGS. 6 and 7, taken along the dashed lines drawn there and corresponding to sections along lines VI-VI and VII-VII from FIG. 8 with two adjacent teeth indicated.

The same reference numerals are used in the following description for identical parts and parts acting in an identical manner.

### DETAILED DESCRIPTION OF THE INVENTION

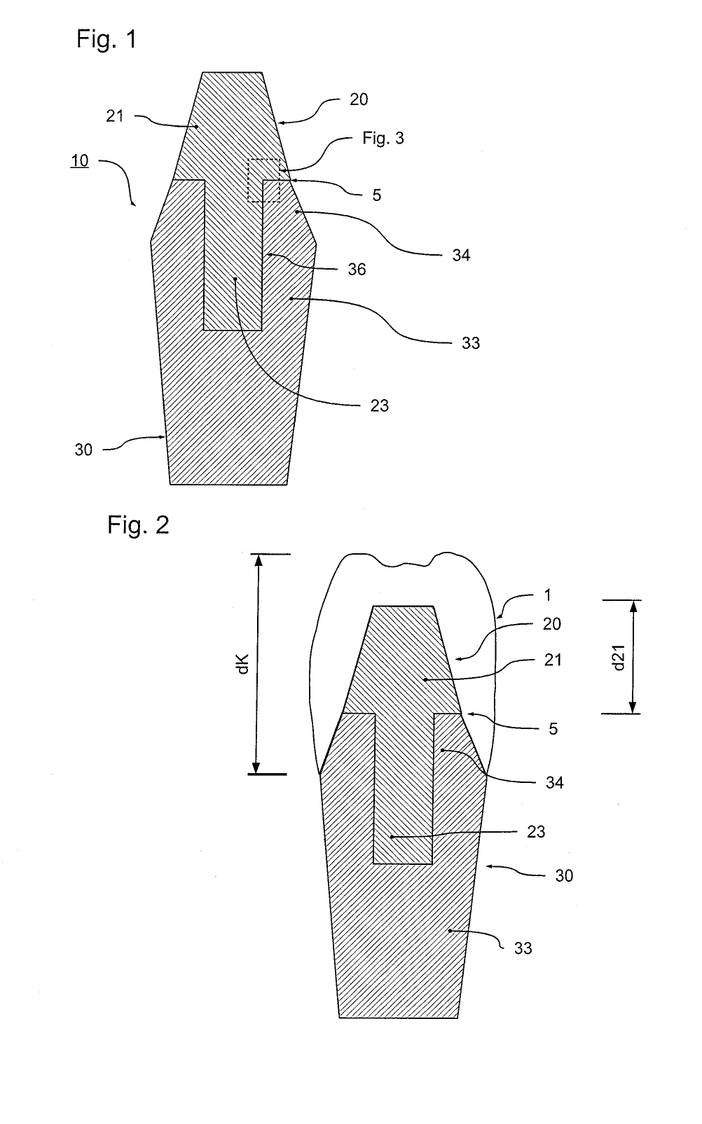

A dental implant according to an embodiment of the invention comprises, as can be seen from FIG. 2, a crown 1, an abutment portion 20 and an anchoring portion 30, wherein abutment portion 20 and anchoring portion 30 form a two-part implant 10 (FIG. 1) on which crown 1 rests. As can be seen from FIG. 1, implant 10 in the present embodiment is a pin, which is rotationally symmetrical about its longitudinal axis, and the diameter of which increases from the bottom upwards in a subgingival section 33 and decreases again beyond subgingival section 33. In cross-section, the region beyond subgingival section 33 has the shape of a truncated cone made up of a top portion 21 of abutment portion 20 and a frustoconical section 34 of anchoring portion 30.

In the present embodiment, abutment portion 21 is formed in one piece with an abutment anchor 23. Abutment top portion 21 and abutment anchor 23 form a mushroom-like structure, wherein the lateral surface of abutment top portion 21 is aligned with the lateral surface of frustoconical section 34 of anchoring portion 30.

Abutment portion 20 may be inserted into a receiving channel 36 of anchoring portion 30 by abutment anchor 23. Receiving channel 36 extends substantially along the longitudinal axis of anchoring portion 30. Abutment anchor 23 may be inserted into receiving channel 36 from above.

To create implant 10, a bonded joint is established between anchoring portion 30 and abutment portion 20 whereby a contact joint 5 is formed between the lateral surfaces of abutment top portion 21 and frustoconical section 34. In particular, abutment anchor 23 is bonded to receiving channel 36. A further contact surface runs perpendicular to the longitudinal axis of implant 10 on which abutment top portion 21 and frustoconical section 34 are in direct contact.

FIG. 4 illustrates this contact region in a view from above. A circular receiving region 37 forms the cap area of frustoconical section 34. Receiving region 37 for abutment portion 20 extends further into receiving channel 36. This is milled out of anchoring portion 30 by three overlapping drilled holes along the longitudinal axis of anchoring portion 30 and in cross-section has a cloverleaf shape (cf. viewing plane of FIG. 4). Abutment anchor 23 is designed to fit this cloverleaf-shaped receiving channel 36 perfectly. The cloverleaf shape secures abutment portion 20 against rotation on anchoring portion 30.

An embodiment of abutment anchor 23 would also be conceivable as a substantially straight prism, based for example on a triangular base area. An anti-rotational joint may likewise be achieved with appropriate adaptation of the triangular area to the cloverleaf area. It is also conceivable to adapt receiving channel 36 to the prism shape. The person skilled in the art working here is aware of embodiments and variations of receiving channel 36 and abutment anchor 23, which are suitable for establishing an anti-rotational joint and for reinforcing the joint of implant 10 in the longitudinal direction.

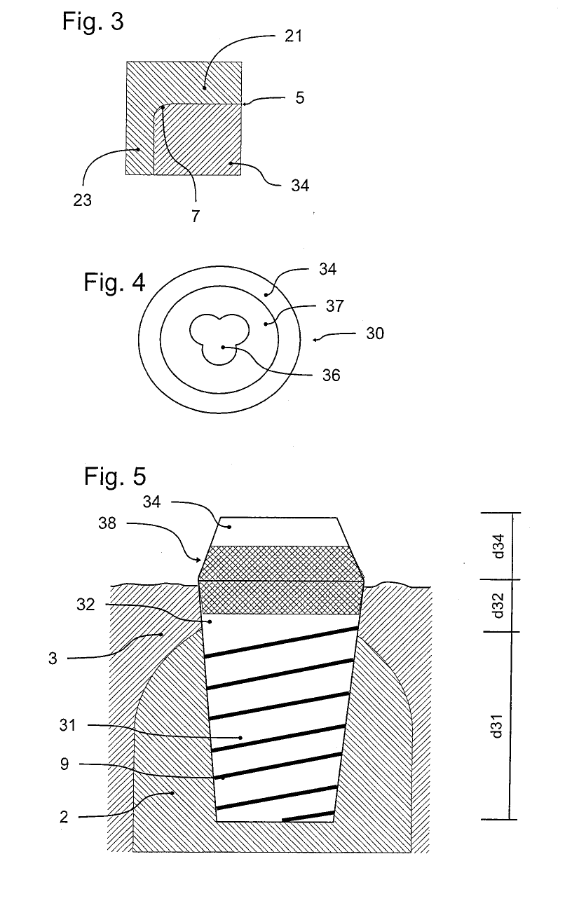

FIG. 3 illustrates a detailed section of the contact region between abutment portion 20 and anchoring portion 30. Represented here in particular is a partial section of abutment top portion 21 and abutment anchor 23, as well as frustoconical section 34 which forms the upper section of receiving channel 36. This upper section has a flattened (rounded or non-sharp) edge 7. This is deburred to prevent excessive single-point loading of abutment anchor 23 in the case of forces occurring laterally and extends along the cloverleaf-shaped opening of receiving channel 36.

FIG. 2 shows implant 10 according to an embodiment of the invention, as already mentioned, with bonded crown 1. A lower section of crown 1 rests directly on the lateral surface of frustoconical section 34 provided for this purpose. Crown 1 and anchoring portion 30 are thus in direct contact. Forces arising, particularly forces which act in the longitudinal direction, are transferred directly to anchoring portion 30. The contact region between crown 1 and the lateral surface of frustoconical section 34 extends around cylindrical anchoring portion 30 and thus seals abutment portion 20 against the outside. In particular, contact joint 5 extending in a circle around the longitudinal axis of implant 10 is covered and sealed by crown 1.

Also conceivable is an implant in which a contact joint 5 arises which lies on a skew plane to the longitudinal axis of anchoring portion 30. For example, it may be desirable for certain areas of application to design the longitudinal axis of abutment top portion 21 skewed to that of anchoring portion 30. Dental implants may have an irregular or garland-shaped contact joint 5, parallel to the curve of the bone for example. The person skilled in the art working here knows how the teaching according to the invention is to be adapted in order to provide a dental implant in which crown 1 overlaps contact joint 5. In particular, he knows how the lateral surface of frustoconical section 34 is to be designed in order to achieve this effect.

FIG. 5 shows a lateral sectional view onto an anchoring portion according to an embodiment of the invention, which has already be implanted in bone 2. The frustoconical section 34 of the anchoring portion clearly protrudes beyond gingiva 3. The subgingival section is surrounded in part by gingiva 3 and is embedded in bone 2 in the lower region. The upper edge of the subgingival section is substantially flush with the natural gingival boundary. The subgingival section is divided into an upper unthreaded section 32 and a lower screw threaded section 31. Screw threaded section 31 has an external screw thread 9 and is screwed into bone 2. Screw thread 9 of screw threaded section 31 has a supporting function during osseointegration.

Screw threaded section 31 illustrated has a height d31 of approx. 7 mm. Adjoining this is unthreaded section 32 with a height d32 of approx. 1.5 mm, and frustoconical section 34 with corresponding lateral surfaces and a height d34 of approx. 2 mm. Together with height d21 of abutment top portion 21 (cf. FIG. 2) the resulting overall height of implant 10 is approx. 14.5 mm. Height dK of crown 1 is approx. 6 mm.

The heights stated are merely intended to exemplify the dental implant's proportions. It is conceivable that they may vary considerably. In particular, height d34 of frustoconical section 34 may vary considerably, for example in the range between 0.25 and 2 mm. Height d31 of screw threaded section 31 may, for example, lie in a range between 5 and 15 mm, height d21 between 3 and 7 mm. Special fabrications with an especially small or especially great height are also conceivable.

The outer surface of subgingival section 33 has a special roughness in order to improve the integration of anchoring portion 30. In the present case, the mean roughness value RA is 9 μm and the mean roughness value RZ is 20 μm. These values were determined over a measuring length (IM) of 10 mm. Normal values for RA lie between 8 and 30 μm, for RZ between 15 and 30 μm. Reference is made to DIN EN ISO 4287 regarding the definitions of RA and RZ.

In the present embodiment, the entire outer surface of subgingival section 33 has a corresponding arithmetical mean roughness value RA. It is also conceivable to equip merely a portion of this outer surface with an appropriately high mean roughness value RA. According to the invention, the roughness of the outer surface of screw threaded section 31 and of unthreaded section 32 may be differently defined.

In the present embodiment, part of anchoring portion 30 is shaded. This colored section 38 (cf. FIG. 5) includes part of the outer surface of unthreaded section 32 as well as part of the outer surface of frustoconical section 34. Colored section 38 has essentially the same shade as crown 1 which was chosen according to the adjacent teeth of the artificial dental prosthesis. As a result, the transition between crown 1 and anchoring portion 30 is inconspicuous when crown 1 is bonded in place. This is particularly advantageous if, when the dental prosthesis is placed, part of anchoring portion 30 is not covered by gingiva 3 and is, therefore, visible. Colored section 38 is preferably chosen such that it does not include screw threaded section 31 at all or only to a very small extent.

Production of an anchoring portion 30 according to the invention includes the modelling of a corresponding green compact. This is provided with the colored section 38 or shaded prior to sintering. Preferably, part of the green compact's surface is roughened prior to sintering to produce an appropriate surface roughness of screw threaded section 30. Roughening may be carried out by blasting or surface finishing, particularly with aluminum oxide.

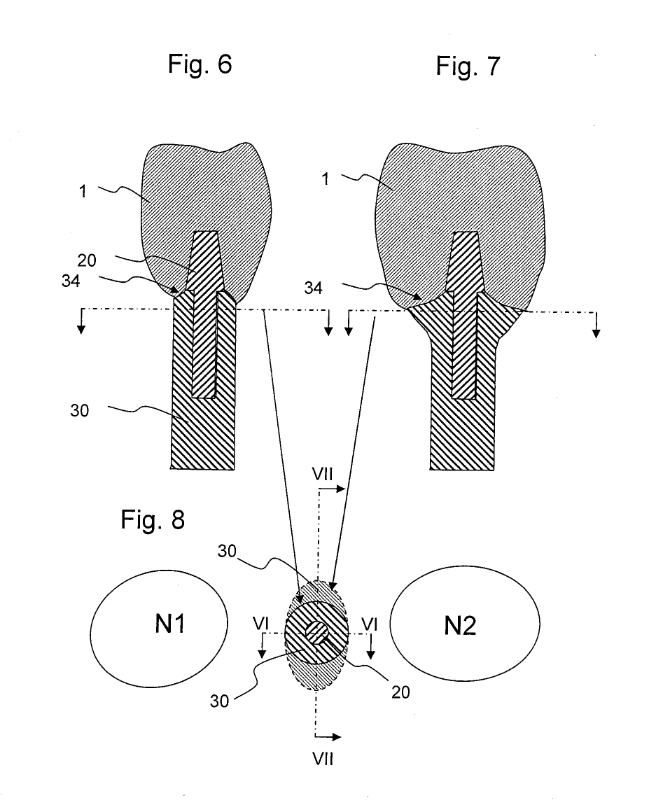

In the embodiment of the invention described in FIGS. 6-8, anchoring portion 30 is formed cylindrically and may (as described previously) have an external thread. The frustoconical section is formed asymmetrically, such that an oval is produced in cross-section (FIG. 8). Thus in one direction, frustoconical section 34 is just as wide at its bottom end as the anchoring portion, but at an angle running perpendicular hereto it is considerably wider. This shaping enables a considerable visual improvement to be achieved. That is, when (as is frequently the case) the anchoring portion has to be inserted relatively far inwardly, thus away from the front margin of the jaw, a relatively pronounced offset in relation to adjacent teeth N1 and N2 occurs with a rotationally symmetrical anchoring portion 30, which offset cannot be filled in “invisibly” by crown 1 alone. Due to the oval shaping, however, a construction emerges which makes it possible to work in alignment with the plane in which adjacent teeth N1 and N2 are located without having to place the hole for the anchoring portion too close to the margin of the jaw bone. The shading described above may also be performed again here such that a particularly good visual image is created.

Further embodiments are described subsequently:

### 1st Embodiment

Artificial dental prosthesis, comprising a crown 1 or similar superstructure and an implant 10 for receiving crown 1, wherein implant 10 has an abutment portion 20 and an anchoring portion 30, wherein the anchoring portion 30 has an abutment portion receiving region for receiving abutment portion 20 and is formed at least in sections from a first material, wherein anchoring portion 30 is joined to abutment portion 20 forming an external contact joint 5, which is covered at least in sections by crown 1, characterized in that abutment portion 20 is formed at least in sections from a second material, which is easier to work on, in particular is softer than the first material.

### 2nd Embodiment

Artificial dental prosthesis according to embodiment 1, characterized in that anchoring portion 30 comprises a crown receiving region for receiving a terminating region of the crown 1.

### 3rd Embodiment

Artificial dental prosthesis according to one of the preceding embodiments, characterized in that anchoring portion 30 has a frustoconical section 34, in particular with a concave lateral surface for receiving part of crown 1.

### 4th Embodiment

Artificial dental prosthesis according to one of the preceding embodiments, in particular according to embodiment 3, characterized in that frustoconical section 34 has a height d34 which is greater than or equal to 3% of the overall height of anchoring portion 30, in particular greater than 5% of the overall height of anchoring portion 30.

### 5th Embodiment

Artificial dental prosthesis according to one of the preceding embodiments, characterized in that anchoring portion 30 is substantially cylindrical in design, wherein the cap area of the cylinder forms at least a section of abutment portion receiving region 37.

### 6th Embodiment

Artificial dental prosthesis according to one of the preceding embodiments, characterized in that anchoring portion 30 comprises a screw threaded section 31.

### 7th Embodiment

Artificial dental prosthesis according to one of the preceding embodiments, characterized in that anchoring portion 30 comprises a receiving channel 36 for receiving abutment portion 20.

### 8th Embodiment

Artificial dental prosthesis according to one of the preceding embodiments, characterized in that the first material belongs to the material group of technical ceramics, in particular oxide ceramics.

### 9th Embodiment

Artificial dental prosthesis according to one of the preceding embodiments, characterized in that anchoring portion 30 is made from zirconium oxide.

### 10th Embodiment

Artificial dental prosthesis according to one of the preceding embodiments, characterized in that the second material is grindable.

### 11th Embodiment

Artificial dental prosthesis according to one of the preceding embodiments, characterized in that the second material belongs to the material group of plastics, in particular CFRP and/or GFRP.

### 12th Embodiment

Artificial dental prosthesis according to one of the preceding embodiments, characterized in that crown 1 is bonded to implant 10.

### 13th Embodiment

Artificial dental prosthesis according to one of the preceding embodiments, characterized in that abutment portion 20 is bonded to anchoring portion 30, in particular in abutment portion receiving region 37.

### 14th Embodiment

Artificial dental prosthesis according to one of the preceding embodiments, characterized in that anchoring portion 30 has a subgingival section 33 with an outer surface of which a substantial region is particularly suited to integration in gingiva 3 and/or bone 2.

### 15th Embodiment

Artificial dental prosthesis according to one of the preceding embodiments, in particular according to embodiment 14, characterized in that a substantial region of the outer surface, preferably more than 30% of the outer surface of subgingival section 33 has an arithmetical mean roughness value RA greater than 8 μm, in particular greater than 12 μm.

### 16th Embodiment

Artificial dental prosthesis according to one of the preceding embodiments, in particular according to embodiment 14 or 15, characterized in that a substantial region of the outer surface, preferably more than 30% of the outer surface of subgingival section 33 is hydroxylated.

### 17th Embodiment

Artificial dental prosthesis according to one of the preceding embodiments, characterized in that anchoring portion 30 is shaded at least in sections.

### 18th Embodiment

Artificial dental prosthesis according to one of the preceding embodiments, characterized in that anchoring portion 30 is designed widened or protruding outwards in its transition to frustoconical section 34.

### 19th Embodiment

Artificial dental prosthesis according to one of the preceding embodiments, in particular according to embodiment 18, characterized in that anchoring portion 30 adjoining frustoconical section 34 as well as frustoconical section 34 itself are designed asymmetrically, deviating from a circular cross-section, in particular with an elliptical cross-section.

Preferred production methods are described subsequently:

### 1st Production Method:

Method for the production of an anchoring portion for an artificial dental prosthesis, in particular according to one of the preceding embodiments, comprising the steps:

Production of a zirconium oxide green compact corresponding to the anchoring portion

Firing/sintering of the green compact, characterized by the step of

Shading of at least one colored section of the green compact prior to the step of firing/sintering of the green compact.

### 2nd Production Method:

Process according to production method 1, characterized by the step of

Roughening, in particular blasting, of at least one special section of the green compact prior to the step of firing/sintering of the green compact.

### 3rd Production Method:

Process according to production method 2, characterized in that roughening includes blasting with aluminum oxide.

### 4th Production Method:

Process according to one of production methods 1 to 3, characterized by the step of forming a screw threaded section in the lower region of the green compact, wherein the colored section is situated above the screw threaded section.

### 5th Production Method:

Process according to one of production methods 1 to 4, characterized in that the green compact is formed substantially cylindrically and colored section includes part of the lateral surface.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-20. (canceled)

21. An artificial dental prosthesis, comprising a crown and an implant for receiving the crown, the implant having an abutment portion and an anchoring portion, the anchoring portion having a first region for receiving the abutment portion and being formed at least in sections from a first material, the anchoring portion having a second region for receiving a terminating region of the crown, the abutment portion being formed at least in sections from a second material, which is softer than the first material, wherein the abutment portion is formed in one-piece in such a manner that it can be ground in situ.

22. The artificial dental prosthesis according to claim 21, wherein the anchoring portion has a frustoconical section for receiving part of the crown.

23. The artificial dental prosthesis according to claim 22, wherein the frustoconical section has a concave lateral surface.

24. The artificial dental prosthesis according to claim 23, wherein the frustoconical section has a height (d34) which is greater than or equal to 3% of an overall height of the anchoring portion.

25. The artificial dental prosthesis according to claim 21, wherein the anchoring portion is substantially cylindrical, and wherein a cap area of the cylindrical anchoring portion forms at least a section of the first region.

26. The artificial dental prosthesis according to claim 21, wherein the anchoring portion comprises a screw threaded section.

27. The artificial dental prosthesis according to claim 21, wherein the anchoring portion comprises a receiving channel for receiving abutment portion.

28. The artificial dental prosthesis according to claim 21, wherein the first material comprises a technical ceramic.

29. The artificial dental prosthesis according to claim 28, wherein the first material comprises an oxide ceramic.

30. The artificial dental prosthesis according to claim 21, wherein the anchoring portion comprises zirconium oxide.

31. The artificial dental prosthesis according to claim 21, wherein the second material comprises a plastic.

32. The artificial dental prosthesis according to claim 31, wherein the second material comprises at least one of carbon fiber reinforced plastic and glass fiber reinforced plastic.

33. The artificial dental prosthesis according to claim 21, wherein the anchoring portion has a subgingival section whose outer surface has a substantial region particularly suited to integration in gingiva and/or bone, and wherein more than 30% of the outer surface of the subgingival section has an arithmetical mean roughness value (RA) greater than 8 μm.

34. The artificial dental prosthesis according to claim 33, wherein the arithmetical mean value (RA) is greater than 12 μm.

35. The artificial dental prosthesis according to claim 33, wherein more than 30% of the outer surface of the subgingival section is hydroxylated.

36. The artificial dental prosthesis according to claim 21, wherein the anchoring portion is shaded at least in sections.

37. The artificial dental prosthesis according to claim 21, wherein the anchoring portion widens or protrudes outwardly in its transition to the frustoconical section.

38. The artificial dental prosthesis according to claim 37, wherein the dental implant adjoining the frustoconical section and the frustoconical section itself are asymmetric, deviating from a circular cross-section.

39. The artificial dental prosthesis according to claim 38, wherein the dental implant adjoining the frustoconical section and the frustoconical section itself are elliptical in cross-section.

40. A method of using an abutment portion in an artificial dental prosthesis a crown and an implant for receiving the crown, the implant having an abutment portion and an anchoring portion, the anchoring portion comprising at least in sections a first material, and the abutment portion comprising a second softer material, the method comprising grinding the abutment portion in situ to adapt it to local conditions after insertion of the abutment portion in the anchoring portion placed in the jaw.
